(19) United States
(12) Patent Application Publication
(10) Pub. No.: US 2012/0110567 A1
(43) Pub. Date: May 3, 2012

(54) OPERATING SYSTEM INSTALLATION USING BUILD PLANS

(76) Inventor: Peter Lyons, Louisville, CO (US)

(21) Appl. No.: 12/914,784

(22) Filed: Oct. 28, 2010

(51) Int. Cl. G06F 9/445

(52) U.S. Cl. 717/177

(57) ABSTRACT

A method for using a build plan for installing an operating system (OS) on a target computing device includes receiving a selection of one or more steps to a base OS build plan; receiving a statement of one or more parameter values for at least one of the steps; creating an extended OS build plan by combining the selected steps with the base OS build plan; and deploying the OS and the extended OS build plan to the target computing device

### BACKGROUND

Customers often encounter problems making extensions and modifications to the process used for operating system (OS) installation as required by their unique environments and constraints. With existing products, OS installation is controlled by vendor-developed code that the customer has little or no ability to understand, extend, or otherwise alter. Thus, dealing with complex customer environments or unusual installations that require modification or extension of the vendor-provided OS installation process is difficult and subject to error. At a minimum, such modifications and extensions require both an in depth knowledge of the internal workings of the vendor-supplied OS installation process as well as computer programming expertise and knowledge that the customer's system administrators may not possess.

### DESCRIPTION OF THE DRAWINGS

The detailed description will refer to the following figures in which like numerals refer to like items, and in which:

FIG. 1 illustrates an example of a system that supports installation of an operating system using a build plan;

FIG. 2 is a flow chart illustrating an example operation for installation of an operating system using an extended operating system build plan; and

FIGS. 3 and 4 illustrate examples of user interfaces provided with the system of FIG. 1.

### DETAILED DESCRIPTION

Computing devices include servers, routers, computers, and other devices having processor logic and memory. Some computing devices, including routers, laptop computers, and desktop computers, typically have an operating system (OS) installed as software. Servers, however, usually come without the OS installed, or with an OS that is not configured according to an organization's specifications. Servers provided without an OS may have installed thereon, as firmware, a basic input/output system (BIOS) that functions to identify, test, and initialize computing system devices such as displays, drives, peripherals, and other hardware. The BIOS also sets the computing system hardware to a known state so that software such as the OS can be loaded and executed. A computing device with only the firmware BIOS installed is referred to as a bare metal computing device. The vendor supplying the OS typically also provides the programming code to install the OS, and the OS installation using the vendor-supplied programming code is intended to be a largely automated process such that no particular knowledge of the installation process, or specialized programming skills are required. The installed OS then supersedes the BIOS firmware functionality to provide software interfaces to applications. An organization's information technology (IT) administrator, as opposed to a skilled computer programmer, typically oversees the OS installation. However, each organization may have a set of unique environmental conditions and other constraints that are not addressed by the vendor-supplied OS installation process. These unique conditions and constraints may necessitate making extensions and modifications to the process used for OS installation. Because the OS installation process is controlled by vendor-developed code processes that the system administrator has little or no ability to understand, making such extension and modifications is difficult and subject to errors.

As disclosed herein, a system to install operating systems, patches, and applications onto computers follows an ordered series of actions to achieve a desired final configuration, while allowing additional software configuration steps to be added by the customer as needed. An OS Build Plan represents an ordered series of actions such as running scripts, installing software, and triggering additional server automation tasks to install and configure a fully functional OS on a blank disk (“bare metal”) computer. This series of actions may include “pre-built” actions provided with an automated installation product as well as customer-defined actions interspersed as needed to meet varying customer requirements. This “extended” installation product is an improvement over current products in that it is controlled by a simple user-friendly graphical interface and can be manipulated by customers who have little computer programming skill.

The extended installation product is based on a generic or base OS Build Plan. An OS Build Plan is a data abstraction modeled and stored in a model repository database. The OS Build Plan is defined as an ordered list of linear action steps to be executed using a global shell execution environment. An OS Build Plan includes a number of discrete steps, including:

Run Server Script—this step executes a server script stored a software library on target servers. Server Scripts are standard OS scripts such as Windows CMD scripts, Visual Basic (VB) Scripts, and Unix Shell Scripts.

Run Global File System Script—this step executes a shell script within a global shell execution environment. This step provides access to the target servers as well as access to a software repository and the model repository.

Install Zip Package—this step executes a Zip file installation from the software repository onto the target servers.

Join Device Group—this step adds a target server to a device group in the model repository.

Attach Software Policy—this step associates a Software Policy from the software repository with a target server for use in a subsequent remediation.
Attach Patch Policy—this step associates a Patch Policy from the software repository with the target server for use in a subsequent remediation.
Start Remediation—this step triggers a software remediation task that provisions patches and application software and configurations.

Extended OS Build Plans are defined using a core management server-generated graphical user interface. The list of OS Build Plan steps can be manipulated (delete, add, modify) and the specific content items and parameters for those steps also can be specified. Each step specifies the step type (one from the above list) as well as an object from the central library (Server Script, GFS Script, Zip package, Device Group, Software Policy, or Patch Policy). An exception is the Start Remediation step, which does not need to be associated with an object from the software repository. Additionally, OS Build Plan steps may have one or more settings appropriate for the step type. These settings include command line arguments for scripts, install paths for Zip packages, and remediate options for the Start Remediation step types.

Once defined, an OS Build Plan may be executed in parallel on one or more target servers. During execution, the OS Build Plan is run using an Automated Platform extension (APX) runtime global shell environment. Each step is executed based on its step type, and near-time progress is reported back to the core management server, where it is made visible to the customer using a user interface.

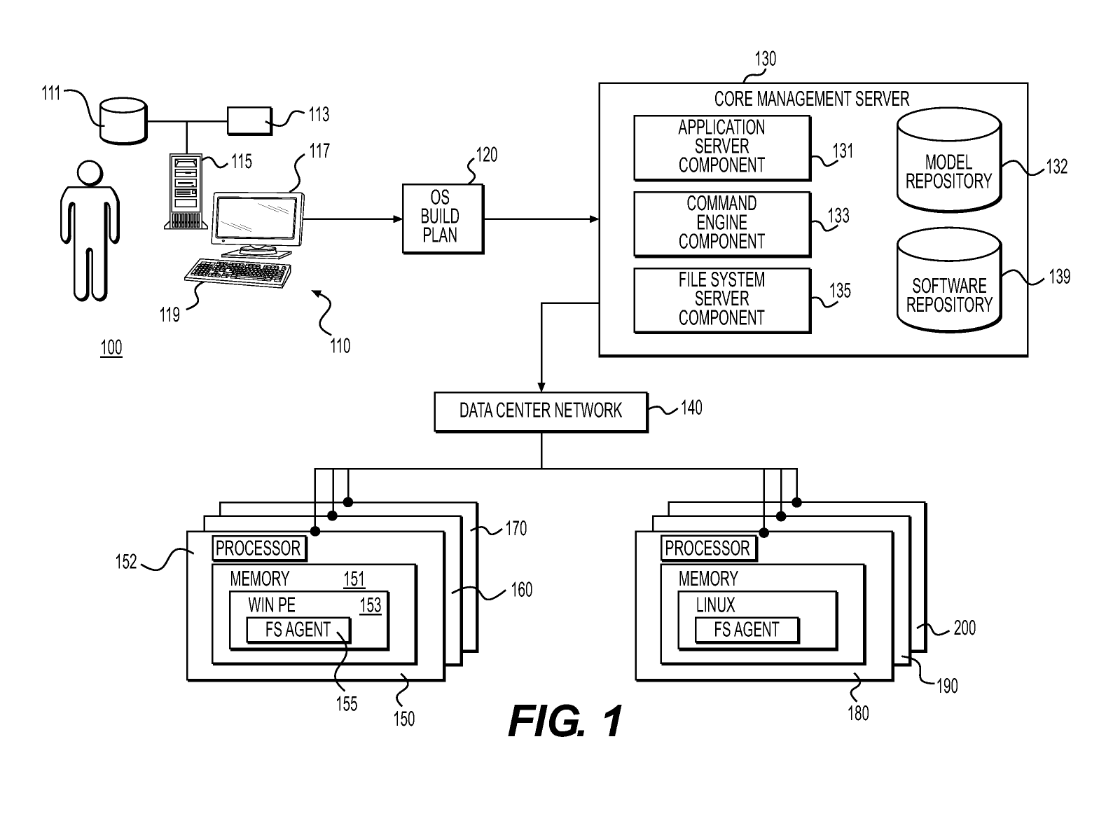

FIG. 1 illustrates an example of a system that supports installation of an operating system using a build plan. The illustrated environment is a large data center having many thousands of servers, arranged in groups. A server that is to receive an OS installation is termed a target server. A server without a fully functional OS or without a SOS is termed a bare metal server.

In FIG. 1, system 100 includes core management server 130, which connects to user interface device 110 and data center network 140. The user interface device 110 may be a computer having data store 111, memory 113, processor 115, and display 117. The user interface device 110 also connects to the network 140. Also connected to the network 140 are target servers 150, 160, 170, 180, 190, and 200, arranged in groups of three servers.

Under direction of a user (e.g., a system administrator) at the user interface device 110, the core management server 130 generates one or more target-specific OS Build Plans 120 that are used for automatic installation of an OS on one or more of the target servers 150, 160, 170, 180, 190, and 200, which are shown arranged in groups of three servers according to the expected operating system of the individual servers. That is, servers 150, 160, and 170 will be configured with a Windows® operating system; servers 180, 190, and 200 will be configured with a Linux® operating system. Server 150 has loaded thereon a service operating system (SOS) 153 (here, Windows Preinstallation Environment, sometimes referred to as Windows PE® or WinPE®, and which is a lightweight version of Windows XP®, Windows Server 2003®, Windows Vista®, Windows 7, or Windows Server 2008 R2 operating systems). The SOS 153 is used for the deployment of the operating system on the server 150. That is, WinPE a 32-bit or 64-bit replacement for MS-DOS, is used during the installation phase of Windows operating systems, and can be booted from computer readable memory 151 (e.g., PXE, CD-ROM, USB flash drive or hard disk) using processor 152. The computer readable memory 151 includes volatile memory (e.g., RAM) and non-volatile memory (e.g., storage) which may be a hard drive. Servers 160 and 170 similarly are configured with WinPe held in memory and executed by a processor.

As can be seen in FIG. 1, the server 150 also includes global file system agent 155 (and each of the other servers 160, 170, 180, 190, and 200 also includes a global file system agent). The global file system agent 155 runs on the server 150 to communicate with the core management server 130. The global file system agent 155 may be provided with the SOS 153 (i.e., embedded in WinPE). The global file system agent 155 has interactive command shell capabilities including reading from and writing to file systems that may exist on the server 150, and running commands executing on the server 150, including running bootstrapping operations.

SOS 153 images containing the agent 155 can boot using Preboot eXecution Environment (PXE) network booting, bootable computer readable medium (e.g., CD-ROM, removable disk, portable memory, etc.) images, or other boot methods. Once loaded onto a bare metal server, the agent 155 collects hardware and/or memory inventory information from the target server and reports this information back to the core management server 130. For example, the agent 155 collects basic processor information such as number of processors and speed, available memory, number and capacity of installed disks, and details of installed network cards. A record in the core management server 130 (i.e., in model repository 132) is created to represent the associated target server, and the target server then is available for management within the system 100.

Once it is available for management within the system 100, the server 150 becomes a managed computing device, and the system administrator then is able to examine and modify any file systems that become available on the server 150. In particular, with the server 150 now “visible,” the system administrator can proceed with installation of a full operating system on the server 150.

As shown in FIG. 1, the servers 150, 160, 170, 180, 190, and 200 are bare metal servers; that is, the servers are installed in the data center without a fully-functional operating system and without any patches and applications. A first step, then, in making the servers 150, 160, 170, 180, 190, and 200 functional is to install an operating system according to one of the OS Build Plans 120.

The core management server 130 uses the OS Build Plans 120 to automatically install a full operating system on the target servers.

The core management server 130 includes specifically programmed processors including application server component 131, command engine component 133, and file system server component 135. Also included in the server 130 are a number of computer-readable media including model repository 137 and software repository 139. The server 130 may include many additional processors and data stores (e.g., persistent and non-persistent memory such as ROM, flash memory and RAM). At least some of the data stores in the server may store the specific applications, programs, installation files, and data used by the components 131, 133, and 135 to perform their designed processing functions.

The application server component 131 manages applications and patches in the data center. The command engine component 133 manages OS installations using an appropriate OS Build Plan. The file system server component 135 manages file systems as installed in the data center.

The model repository 137 stores OS Build Plans and server configuration information. The software repository 139 stores operating systems, applications, and patches.

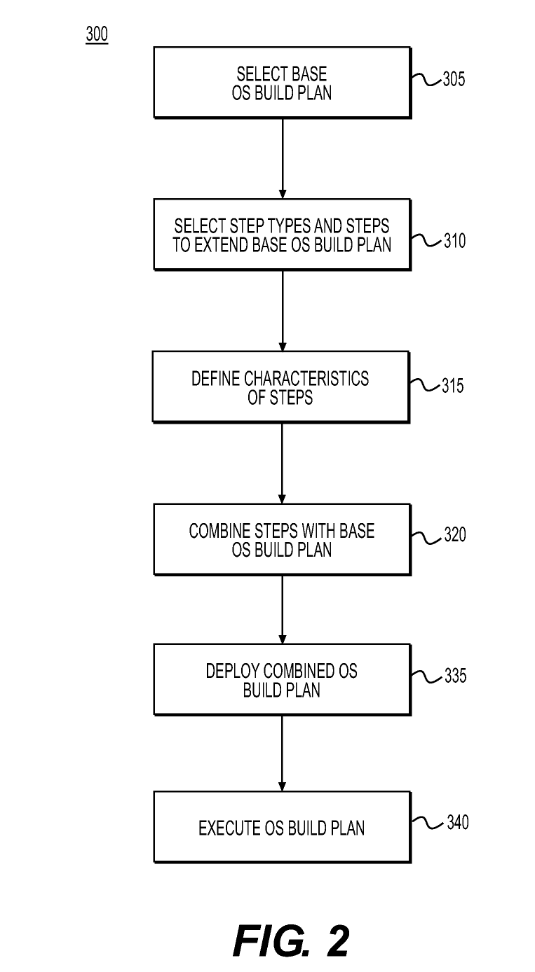

FIG. 2 is a flow chart illustrating an example operation for installation of an operating system in the environment of FIG. 1. In FIG. 2, operation 300 begins in block 305 when a system administrator, at user interface 110, loads a service operating system, if required, and selects a base OS Build Plan that is appropriate or intended for a particular server or server group, and the command engine component 133 receives the system administrator's selection. For example, server 150 may exist as a managed server with service operating system (SOS-WinPE) 153 installed. An appropriate base OS Build Plan accounts for the existing installation of the WinPE SOS 153. The component 133 may provide, through the user interface, a list or menu of available base OS Build Plans that are appropriate for Windows®.

In block 310, the core management server 130 presents the system administrator with a menu of OS Build Plan steps appropriate for the selected base build plan and receives a selection of desired steps by which to extend the base OS build plan. In block 315, the core management server 130 receives inputs from the system administrator to define the characteristics or parameters of the selected OS Build Plan steps.

In block 320, the core management server 130, as directed by the system administrator, combines the selected OS Build Plan steps with the base OS Build Plan to generate an extended OS Build Plan specific to the server 150, and stores the build plan.

The operation 300 then moves to block 335 and the core management server 130 uses the extended OS Build Plan to deploy the OS onto the server 150. In block 340, the server 150 executes installation of the OS according to the OS Build Plan.

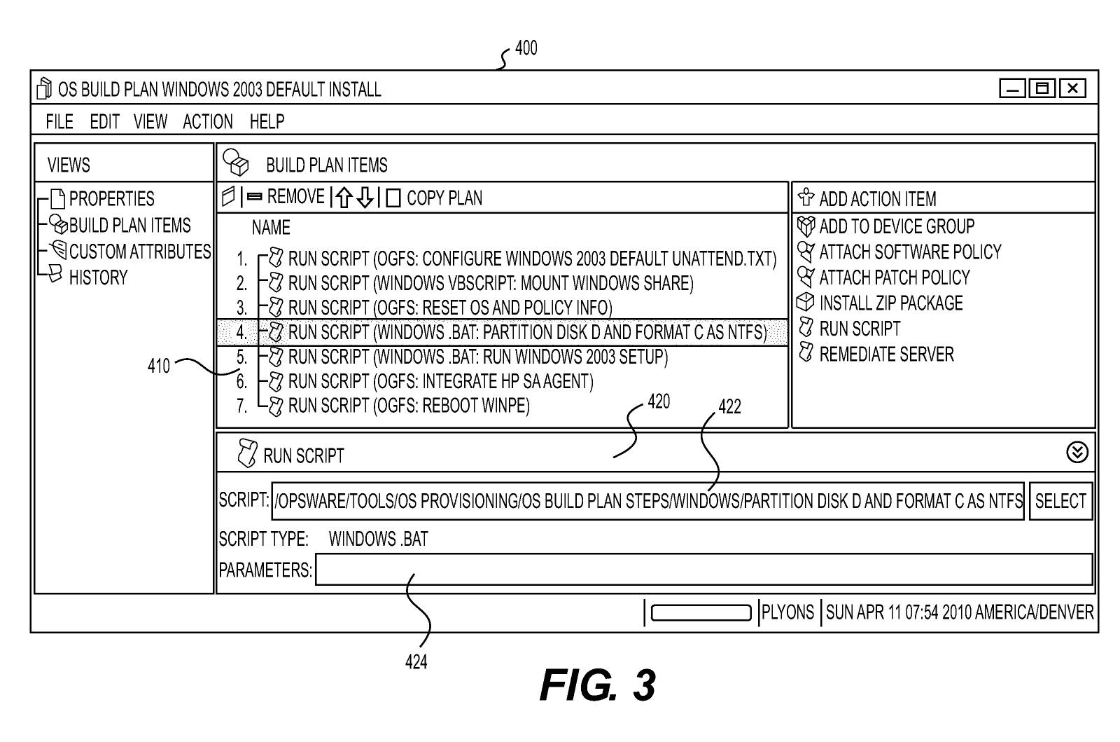

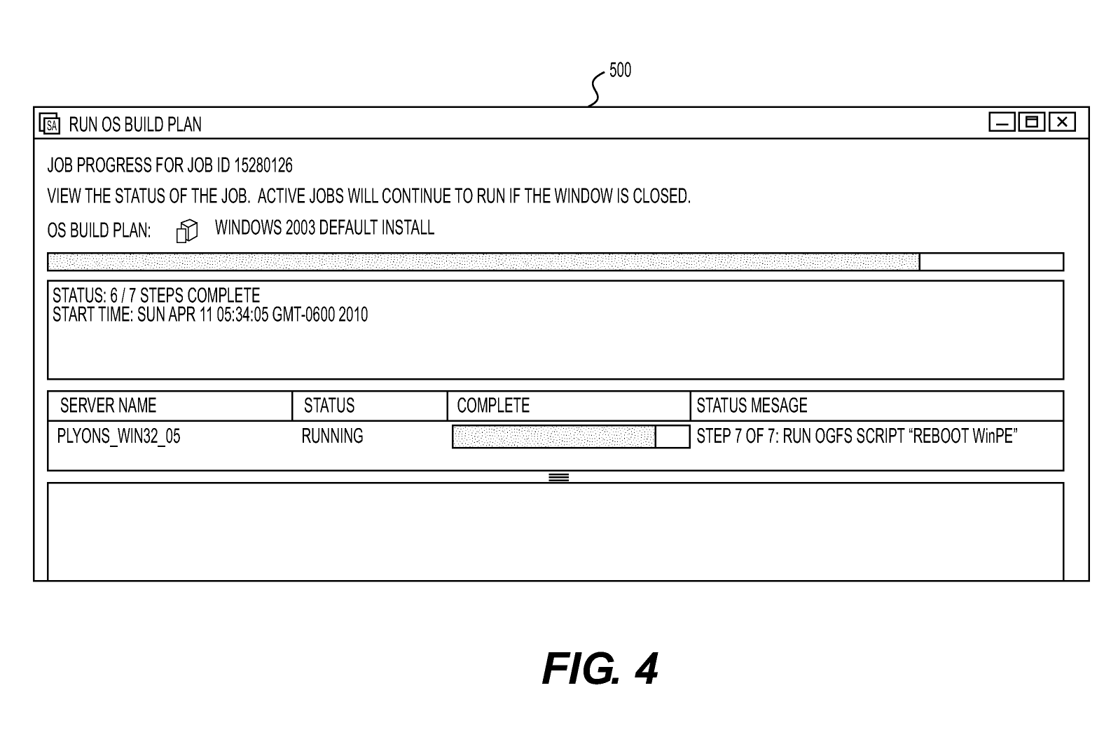

FIGS. 3 and 4 illustrate examples of user interfaces provided with the system of FIG. 1. In FIG. 3, user interface 400 shows a window 410 displaying the OS Build Plan modification steps that allow a system administrator to select one or more steps by which a base OS Build Plan can be extended to suit the specific configuration of the server 150 as reported by the server's installed agent 155 and stored in the server 130. As can be seen in window 410, step 4, one of seven available “Run Script” steps, is selected. The selected “Run Script” step partitions disk 0 and formats Disk C as a new technology file system (NTFS) disk. In window 420, the core management server 130 displays the “Run Script” steps including script 422, and provides parameters window 424 by which the system administrator can adjust the parameter values of the “Run Script” step.

FIG. 4 illustrates user interface 500, which is a status display of the OS installation being executed on the server 150 according to base OS Build Plan Windows 2003 Default, as extended by the system administrator with steps 1-7. As can be seen in FIG. 5, the status is installation of the OS according to an extended OS Build Plan, with steps 6 of 7 completed on server pylons_win32_{—}05 (i.e., server 150 of FIG. 1).

What is claimed is:

1. A method of using a build plan for installing an operating system (OS) on a target computing device, comprising:
receiving a selection of one or more steps to a base OS build plan;
receiving a statement of one or more parameter values for at least one of the steps;
creating an extended OS build plan by combining the selected steps with the base OS build plan; and
deploying the OS and the extended OS build plan to the target computing device.

2. The method of claim 1, wherein the steps to be selected include Run Server Script, Run File System Script, Install Zip Package, Join Device group, Attach Software Policy, Attach Software Patch Policy, and Start Remediation.

3. The method of claim 1, wherein the target computing device is configured with a service operating system (SOS), and wherein the OS is compatible with the SOS.

4. The method of claim 3, further comprising installing the OS on the target computing device according to the extended OS build plan.

5. The method of claim 1, wherein the target computing device is configured with a functional operating system.

6. The method of claim 5, further comprising replacing the functional operating system with the OS.

7. The method of claim 1, wherein the target computing device is a bare metal computing device, the method further comprising installing a service operating system (SOS) on the target computing device.

8. The method of claim 1, further comprising providing a user interface, wherein the steps and the statement of parameter values are provided.

9. A computer readable medium including programming for execution by a processor, the programming, when executed by the processor, implementing a method for installing an operating system (OS) using a build plan, the method, comprising:
receiving a selection of one or more steps to a base OS build plan;
receiving a statement of one or more parameter values for at least one of the steps;
creating an extended OS build plan by combining the selected steps with the base OS build plan; and
deploying the OS and the extended OS build plan to the target computing device.

10. The computer readable medium of claim 9, wherein the steps to be selected include Run Server Script, Run File System Script, Install Zip Package, Join Device group, Attach Software Policy, Attach Software Patch Policy, and Start Remediation.

11. The computer readable medium of claim 9, wherein the target computing device is configured with a service operating system (SOS), and wherein the OS is compatible with the SOS.

12. The computer readable medium of claim 11, the method further comprising installing the OS on the target computing device according to the extended OS build plan.

13. The method of claim 9, wherein the target computing device is configured with a functional operating system.

14. The method of claim 13, the method further comprising replacing the functional operating system with the OS.

15. The method of claim 9, wherein the target computing device is a bare metal computing device, the method further comprising installing a service operating system (SOS) on the target computing device.

16. The method of claim 9, further comprising providing a user interface, wherein the steps and the statement of parameter values are provided.

17. A system for installing an operating system (OS) on a target computing device using a build plan, comprising:
a core management server, comprising:
a command engine component programmed to generate an extended OS build plan based on a combination of a based OS build plan and one or more designated and defined steps, and
an application server component programmed to generate one or more user interfaces wherein the steps are designated and defined; and
a server on which the user interface is provided.

18. The system of claim 17, wherein the steps to be designated include Run Server Script, Run File System Script, Install Zip Package, Join Device group, Attach Software Policy, Attach Software Patch Policy, and Start Remediation.

19. The system of claim 17, wherein the target computing device is a bare metal computing device.

20. The system of claim 19, wherein the core management server further comprises a file system server component that configures the target computing device with a service operating system (SOS), and wherein the OS is compatible with the SOS.
